(19) United States
(12) Patent Application Publication
(10) Pub. No.: US 2005/0038777 A1
(43) Pub. Date: Feb. 17, 2005

(54) Querying data in a highly distributed management framework

(76) Inventors: Eric Anderson, Alpine, UT (US); Dean L. Schmidt, Scottsdale, AZ (US); Warren D. Cave, Highland, UT (US); David Baldwin, Layton, UT (US); Norm Paxton, Pleasant Grove, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 10/822,438

(22) Filed: Apr. 12, 2004

Related U.S. Application Data
(60) Provisional application No. 60/462,207, filed on Apr. 11, 2003.

(51) Int. Cl. G06F 17/30

(52) U.S. Cl. 707/3

(57) ABSTRACT

Implementation of the present system takes place in association with a computer device that is used to obtain and process data. In particular, implementation of the present system embraces the ability to query a management framework for any data. In at least one implementation, the querying occurs down to the specific requests for performance of the talents in the system, and results are returned that provide a viewable report. Accordingly, the systems and processes include the obtaining of information all the way down to talents and the receiving of a report all in the same management framework.

### 1. RELATED APPLICATIONS

The present utility application claims priority to a provisional application No. 60/462,207, filed Apr. 11, 2003, titled QUERYING DATA IN A HIGHLY DISTRIBUTED MANAGEMENT FRAMEWORK.

### BACKGROUND OF THE INVENTION

1. Field of the Invention

The present invention relates to querying a management framework for information. More particularly, the present invention relates to systems and methods for querying data down to specific task requests for the performing of talents within a system, and receiving back task responses that describe the results of performing the talents.

2. Background and Related Art

The emergence of the information age has demonstrated the value of obtaining information. Currently, a variety of techniques are available relating to obtaining and processing information. In current management products, a system includes a variety of agents, wherein each agent sits on a box and collects data local to itself.

Examples of obtaining information include performing a request for information. One technique for making such a request for information includes choosing parameters from a menu, wherein a database system presents a list of parameters from which a user may choose. While this technique provides a menu guide for a user to simplify the process, it is a very inflexible option. Another technique for making a request for information is a query by example, which includes having a blank record presented that allows the user to specify fields and values that device the request or query. Another technique for making a request for information is a language query, wherein a request for information is made in the form of a stylized query that must be written in a special query language. While this technique is available, it requires the user to learn a specialized language.

Thus, while techniques currently exist that are used to obtain and process information, challenges still exist with the techniques currently available. Accordingly, it would be an improvement in the art to augment or even replace current techniques with other techniques.

### SUMMARY OF THE INVENTION

The present invention relates to querying a management framework for information. More particularly, the present invention relates to systems and methods for querying data down to specific task requests for the performing of talents within a system, and receiving back task responses that describe the results of performing the talents.

Implementation of the present invention takes place in association with a computer device that is used to obtain and process data. In particular, implementation of the present invention embraces the ability to query a management framework for any data. In at least one implementation, the querying occurs down to the specific requests for performance of the talents in the system, and results are returned that provide a viewable report. Accordingly, the systems and processes of the present invention include the obtaining of information all the way down to talents and the receiving of a report all in the same management framework.

In at least one implementation, a system includes a web application and a manager service (ISPM manager). The ISPM manager serves a variety of purposes, including providing an aggregation service and a controller service. The aggregation service relates to a central point of control, wherein requests from the web go to that manager. The manager broadcasts the requests out to the talents, which are the collection devices out in the network. The data is grabbed and a result is returned. In one implementation the result is written directly to a database. In another implementation, the result is reported back through the manager to the web application. Thus, the ISPM manager includes the ability to distribute. In addition, the controller service relates to the ISPM manager maintaining control of a database that handles logging data, configuring data, etc.

Another part of the architecture is a talent provider or agent. Communication occurs with an agent, which may contain an application that sits on a box (e.g., a window box, a netware box, etc.) A set of functionality modules are loaded, wherein the functionality modules are talent providers. A talent provider enables an expression of a set of capabilities for data that can be collected. The finite element of what can be collected is in what's called a talent, which is a plug to the talent provider. A talent provider may have talents that are local or otherwise in an environment. Communication occurs by sockets with a talent to collect desired data. Accordingly, an agent box is made to be distributable. Thus, for applications that are highly distributed (e.g., SAP), talent providers may be provided in all the places the distributed pieces are of SAP. They collect the data and bring it all back to that a talent provider who through his agent is going to flow it back to the manager so we are actually collecting in a distributed fashion just as the application is distributed.

While the methods and processes of the present invention have proven to be particularly useful in the area of a web based management framework, those skilled in the art can appreciate that the methods and processes can be used in a variety of different applications and in a variety of different system configurations.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative networked configuration;

FIG. 3 illustrates a representative architectual overview;

FIG. 4 illustrates representative product components;

FIG. 5 illustrates a representative manager service;

FIG. 6 illustrates a representative agent;

FIG. 7 illustrates another representative agent;

FIG. 8 illustrates information relating to a representative service; and

FIG. 9 illustrates representative option values.

### DETAILED DESCRIPTION OF THE INVENTION

The present invention relates to querying a management framework for information. More particularly, the present invention relates to systems and methods for querying data down to specific task requests for the performing of talents within a system, and receiving back task responses that describe the results of performing the talents.

Embodiments of the present invention take place in association with a computer device that is used to obtain and process data. In particular, embodiments of the present invention embrace the ability to query a management framework for data. In at least one embodiment, the querying occurs down to the specific requests for performance of the talents in the system, and results are returned that provide a viewable report. Accordingly, the systems and processes of the present invention include the obtaining of information all the way down to talents and the receiving of a report all in the same management framework.

To facilitate understanding of the systems and methods of the present invention, the following glossary of terms is provided, wherein each term is individually described.

Talent—Capability to perform a specific action. A talent is a concept not an entity. A provider is the binary implementation of a talent. Each talent is defined by a GUID that is consistent for all instances of the talent provider.

Task Request—A request to perform a talent. The request may be an interactive request from a client (such as “change my eDirectory password”) or may be a definition of a scheduled query.

Task Response—A document that describes the results of performing a talent.

Talent Agent—Acts effectively as a “router” for talent requests that can be performed on a specific box. All incoming requests will be routed through the talent agent and dispatched to the specific talent provider that implements the talent. A talent agent may contain embedded “native talents”, such as nvTAnds.exe providing the eDirectory Query talent without requiring a plug-in provider.

Talent Provider—Implementation of one or more talents. Providers are effectively plug-ins to the windows version of the Talent Agent (nvTAwin.exe).

Configuration Database—System configuration database used to manage the various components of the system. This database is designed to be only accessed through the manager service.

(Policy) Manager—Overall “master” service (nvPMgr.exe) responsible for task dispatching and scheduling. Tasks to be performed will be sent to one or more Talent Agents for execution. The manager will also collect one or more task responses for a given task request and forward those results to the entity that initiated the task request.

The following disclosure of the present invention is grouped into two subheadings, namely “Exemplary Operating Environment” and “Querying Data in a Distributed Management Framework.” The utilization of the subheadings is for convenience of the reader only and is not to be construed as limiting in any sense.

### Exemplary Operating Environment

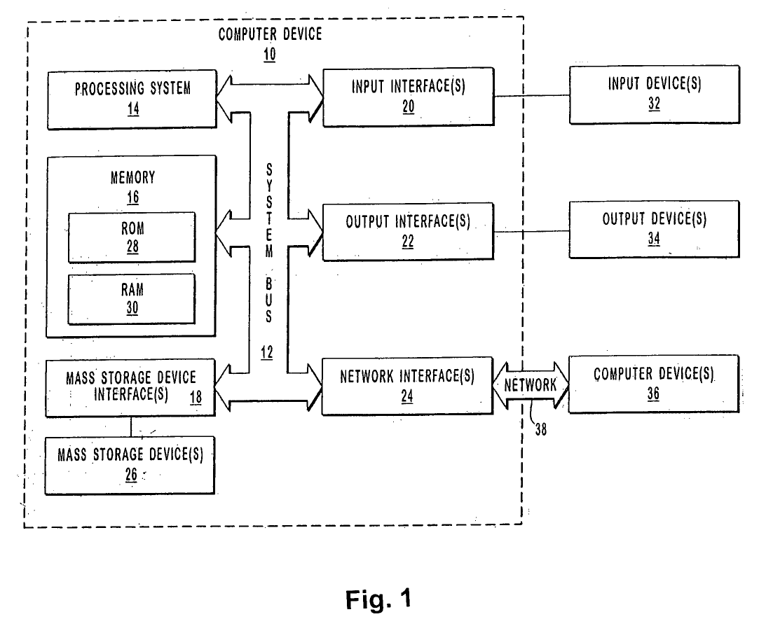

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette. an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

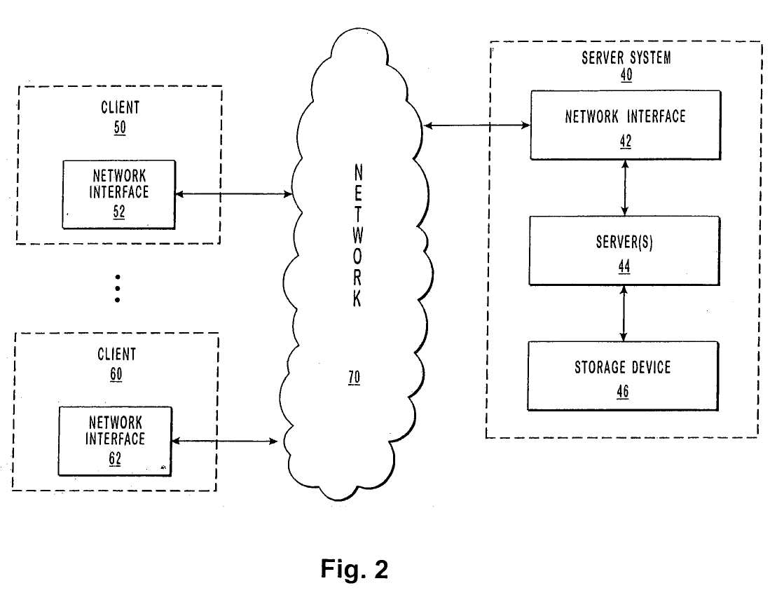

While those skilled in the art will appreciate that the invention may be practiced in networked computing environments with many types of computer system configurations, FIG. 2 represents an embodiment of the present invention in a networked environment that includes a variety of clients connected- to a server via a network. While FIG. 2 illustrates an embodiment that includes multiple clients connected to the network, alternative embodiments include one client connected to a network, one server connected to a network, or a multitude of clients throughout the world connected to a network, where the network is a wide area network, such as the Internet.

In FIG. 2, a representative networked configuration is provided. Server system 40 represents a system configuration that includes one or more servers. Server system 40 includes a network interface 42, one or more servers 44, and a storage device 46. A plurality of clients, illustrated as clients 50 and 60, communicate with server system 40 via network 70, which may include a wireless network, a local area network, and/or a wide area network. Network interfaces 52 and 62 are communication mechanisms that respectfully allow clients 50 and 60 to communicate with server system 40 via network 70. For example, network interfaces 52 and 62 may be a web browser or other network interface. A browser allows for a uniform resource locator (“URL”) or an electronic link to be used to access a web page sponsored by a server 44. Therefore, clients 50 and 60 may independently access or exchange information with server system 40.

As provided above, server system 40 includes network interface 42, servers 44, and storage device 46. Network interface 42 is a communication mechanism that allows server system 40 to communicate with one or more clients via network 70. Servers 44 include one or more servers for processing and/or preserving information. Storage device 46 includes one or more storage devices for preserving information, such as a particular record of data. Storage device 46 may be internal or external to servers 44.

### Querying Data in a Distributed Management Framework

As provided herein, embodiments of the present invention relates to querying a management framework for information. More particularly, the present invention relates to systems and methods for querying data down to specific task requests for the performing of talents within a system, and receiving back task responses that describe the results of performing the talents.

Embodiments of the present invention embrace the ability to query a management framework for data. In at least one embodiment, the querying occurs down to the specific requests for performance of the talents in the system, and results are returned that provide a viewable report. Accordingly, the systems and processes of the present invention include the obtaining of information all the way down to talents and the receiving of a report all in the same management framework.

In at least one embodiment, a system includes a web application and a manager service (ISPM manager). The ISPM manager serves a variety of purposes, including providing an aggregation service and a controller service. The aggregation service relates to a central point of control, wherein requests from the web go to that manager. The manager broadcasts the requests out to the talents, which are the collection devices out in the network. The data is grabbed and a result is returned. In one implementation the result is written directly to a database. In another implementation, the result is reported back through the manager to the web application. Thus, the ISPM manager includes the ability to distribute. In addition, the controller service relates to the ISPM manager maintaining control of a database that handles logging data, configuring data, etc.

Another part of the architecture is a talent provider or agent. Communication occurs with an agent, which may contain an application that sits on a box (e.g., a window box, a netware box, etc.) A set of functionality modules are loaded, wherein the functionality modules are talent providers. A talent provider enables an expression of a set of capabilities for data that can be collected. The finite element of what can be collected is in what's called a talent, which is a plug to the talent provider. A talent provider may have talents that are local or otherwise in an environment. Communication occurs by sockets with a talent to collect desired data. Accordingly, an agent box is made to be distributable. Thus, for applications that are highly distributed (e.g., SAP), talent providers may be provided in all the places the distributed pieces are of SAP. They collect the data and bring it all back to that a talent provider who through his agent is going to flow it back to the manager so we are actually collecting in a distributed fashion just as the application is distributed.

In one embodiment, the manager and agents embrace a Windows® environment. Other embodiments embrace other platforms, including Java. In one embodiment, a single manager is provided within a system. In another embodiment, multiple managers function as a cluster. In the cluster, the managers share across themselves. Accordingly, if one of them goes down it requests the data it sent out to perform a talent so that the information will come back and even though that particular manager is down, the request will still be able to get out where its supposed to go because all of the other managers know about that request and where it came from initially.

A manager is able to do a variety of different tasks. For example, it functions as a central dispatching mechanism so if a request comes in from whatever mechanism (e.g., a web user interface), it will determine from a registry all of the talents that are out there, the platforms they are allowed to talk to, who can perform a specific action, etc. One or more of the talents out in the network may be responsible for sending that out and if it's executed successfully, that usually will be the case it will just be sending it to one but if it errors out for some reason it will continue to try and send it together with compatible talents in the network.

Another task that the manager can perform relates to system management. For example, one request may be sent to the manager requesting all the data collected at the internal state information in different talents and agents on the network. The manager can handle the broadcasting of that specific request out to whatever compatible components of the system are out there.

The manager also may perform scheduling of a query based on actions. In one embodiment, they are stored in each configuration database and the manager periodically checks which ones need to be scheduled and will dispatch that out to the talents to be performed. In a further embodiment, agent or talent atonomy exists where for some reason the connection gets broken between a talent and an agent, and the manager goes on collecting its data and performing on a schedule basis and then it will dump back the data to the manager when it has that connection restored.

In one embodiment, a specific request is provided, such as a request to collect from 100 different netware servers. The manager breaks the request up into different pieces to send to the different agents out there that can each talk to, for example, 10 different servers. So what you end up having is the manager has to keep track of the fact that this one request it got from the web actually got broken into 10 different pieces and its got to consolidate all of those results and monitor the status of that performing of that action across all of those different pieces that's another one of it's major things that it does.

The request may come in typically through XML representations of the request. They can come in through a socket connection or through an RPC mechanism.

A system wide database is provided that includes all of the configuration information and some of the internal state information about the manager. A variety of requests that are performed to get data out of that database and present back to the requestor. Accordingly, it provides a secure access layer to that database and it includes the ability to audit all interactions. So if you want to know who's defining new policies within your environment and who had deleted them, the information may be tracked and obtained since all of the requests have to come in through the manager and the manager will easily be able to track that and write that out to an audit database.

The foregoing discussion relates to architecture, including the manager, the agent and those items being distributed from each other. At least some embodiments embrace self-describing data and/or a self-describing viewer display. As mentioned above, we broke apart where there traditionally was an agent running on a machine. One could go and view that data that was broken apart and gave ourselves access through that through the manager that controlling the overall process in today's view, the ability to actually funnel some of that information to a remote console via a socket connection and using XML as the data transport.

Relating to the distributed nature, we can now pick new agents and agents can add to agents and it's a product involved suddenly you have a display issue with this remote console. Accordingly, a self-describing view or self-describing data or self-describing display is included. Thus, not only is the data that's going to be displayed sent across that socket but the way in which its supposed to be displayed or the style or what needs to be done with that is also sent and streamed from that manager over to the view. So, a system may be reconfigured by the manager and the self-describing view mechanism may be utilized. As such, the view of the console may be expanded without changing any of the console codes. Also, the other thing we have done with the dynamic port is not only are we showing them the data but we are working them in the self-describing view that we put together and the ability to actually process the data and reconfigure it on the fly from the users point of view so we can tell them what date is there they can give us some additional parameters and we can then reformat that in yet another variation based on user input of that already self-describing view on the data that was sent from one of the agents through the manager.

The following is a practical example: Let's say that we are monitoring two different types of operating systems. And there are different parameters for instance on Windows® and Linux® and NetWare® there are different parameters that you want to monitor that are unique to the platform. Some exist only on NetWare® some exist only on Linux® and some exist only on Windows®, yet there are some parameters that are common amongst them all. So, the agent monitors those three different platforms and you want to put that report together whether it's a combined report or just an individual report the manager using that self-describing view can include without additional changes on the console display side those additional parameters how they should be displayed what the user can or may not do to manipulate that, graph it or do other things like that. Graphing is an example of manipulation that they could do on the data once they have received it. That is a simple concept of additional data parameters being monitored that are unique by platform but still need to be included in a common combined report or even just a report that may vary based on platform, wherein it is able to be self-described and adaptation applies to any new agent or any new talent that's placed out on any box that's put into the system. So as the system expands and grows, the self-describing nature keeps us from having to make many code changes on the console view. This provides a very powerful way of expanding the system and even adding new capabilities without having to retool the whole system.

The following relates to a web password utility. A self-service web password may be changed and that can be extended to be a self-service change. If there are other things that a user needs to do (e.g., something that an organization or an adminstrator would like to delegate) in the password stage we have the ability to set up an identity in a different system and the administrator can allow or our system will allow the administrator to identify any type of characteristic of a user to be used for identification and allow subsequently to change their password.

By way of example, for an email address a user forgot his/her password. Hence he needs to change his password but he can't because he forgot it. Either that user can set that up or he can have some corporate profiles for those. It doesn't have to be email. Our current system will allow them to set almost any attribute in the directory to be used for that identification. And another point is if there is more than one criteria (e.g., if your user name is Jay Smith and there are more Jay Smith's) we give you a complete list of Jay Smith's with some more descriptive criteria and then the user selects the one that they believe they are. By that selection the criteria for challenge questions would pop up for that user selection so that they could enter the questions correctly and then perform that action. While this relates to a password change, there are other things for self-service. For example, one relates to provisioning self-service activities when a user moves to a different organization or location, wherein either he or his manager would be able to provision that themselves. Thus, embodiments of the present invention also embrace delegating provisioning. In one embodiment, a notion of having an identity being linked across separate platforms is provided, wherein we are able to change those immediately with immediate feedback using the system.

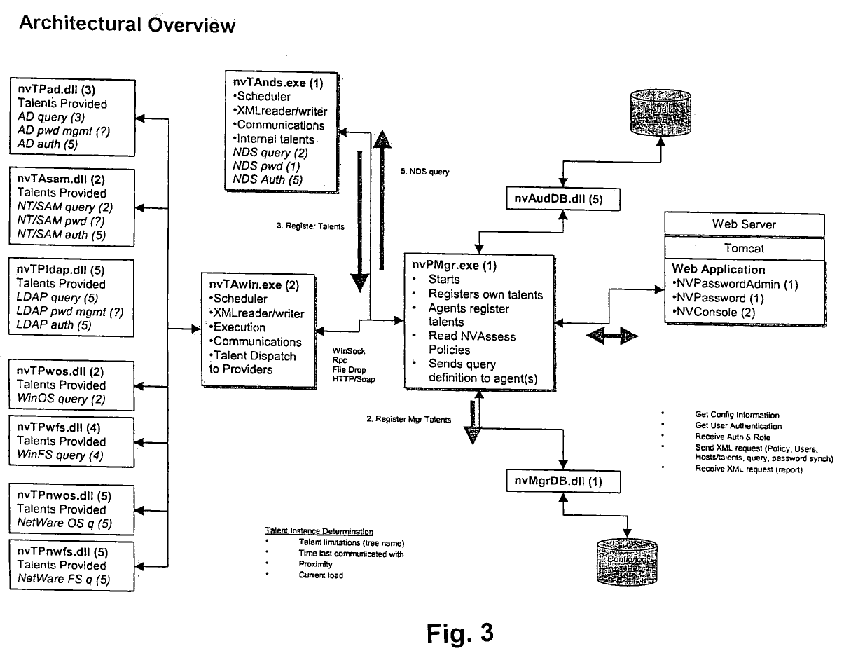

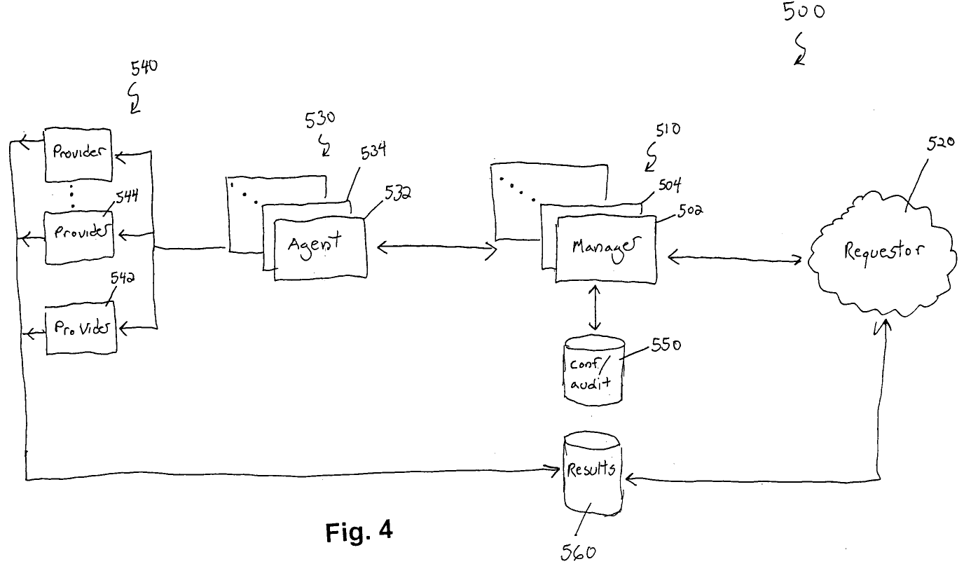

With reference now to FIG. 3, a diagram is provided relating to a representative architectural overview. The architectural overview illustrates one embodiment of a data query system including a manager module (nvPMgr.exe (1)), two different talent agents (nvTAnds.exe (1); nvTAwin.exe (2)), a plurality of different talent providers (nvTPads.dll (3); nvTAsam.dll (2); nvTPldap.dll (5); nvTPwos.dll (2); nvTPwfs.dll (4); nvTPnwos.dll (5); nvTPnwfs.dll (5)), an audit database, a config/log database, and a web server. These elements will be described in more detail with reference to FIG. 4.

With reference now to FIG. 4, an embodiment of a data querying system in accordance with the present invention is designated generally at 500. The data querying system 500 further includes a requester 520, at least one manager module 510, at least one talent agent 530, at least one talent provider 540, a configuration database 550, and a results database 560. The requestor 520 is an external source of query requests. The requester 520 may be connected to the remainder of the data querying system 500 via the Internet, a LAN, a dial-up connection, etc. The requestor 520 may also include a plurality of requestors communicating through the same node. The at least one manager module 510 includes a first manager module 502 and a second manager module 504. The dots behind the second manager module 504 indicate that additional manager modules may be incorporated into the architecture while remaining consistent with the present invention. The at least one talent agents 530 include a first agent 532 and a second agent 534. The dots behind the second agent 534 indicate that additional agents may be incorporated and remain consistent with the present invention. Each of the talent agents 530 communicate with each of the manager modules 510 individually. Therefore, if one talent agent 530 fails, the manager modules 510 are able to reroute the task request to a different talent agent. Likewise, each of the talent agents 530 communicate with at least one talent provider 540. Alternatively, some of the talent agents 530 may not communicate with any of the talent providers 540. The talent providers 540 further include a first talent provider 542 and a second talent provider 544. The dots above the second talent provider 544 indicate that additional talent providers may be incorporated and remain consistent with the present invention. Although the diagram shows a single communication line between the talent agents 530 and the talent providers 540, each talent agent 530 communicates individually with one or more of the talent providers 540.

In operation, the manager modules 510 receive task requests from the requestor 520. The task requests involve requesting the data query system 500 to perform a particular talent. Some talents are merely actions while others require the data query system 500 to generate output results. The manager modules 510 analyze the configuration database 550 to identify which of the at least one talent agents 530 correspond to the requested task. The talent agents 530 regularly register their available talent provider talents and native talents with the manager modules 510 and the manager modules 510 record/update this information to the configuration database 550. Native talents are talents which an individual talent agent can perform itself without relying on a talent provider. In addition, the manager modules 510 register their own native talents on the configuration database 550. Once the manager modules 510 identify the appropriate talent agents 530 for the requested task, the manager module send the task request to at least one of the talent agents 530. The manager modules 510 may request that a single talent agent 530 perform the requested task, or it may ask several appropriate talent agents 530 to perform the requested task. If several talent agents 530 are requested, the requested task may either be divided among them to increase efficiency or kept intact for redundancy purposes. If the task request pertains to a native talent, the talent agent(s) 530 will perform the task themselves. If however, the task request pertains to a non-native talent, the talent agent(s) 530 who were sent the task request will initiate the appropriate talent provider 540 to perform the requested task. If the requested task pertains to a talent that involves the generation of output data, the talent providers 540 will output the appropriate data to the results database 560 which is available for the requestor. In addition, the various task requests by the requestor are recorded by the manager module in the audit database 550. The audit database and the configuration database can reside on the same database 550 as shown in the figure or they can be separate.

Thus, as discussed herein, the embodiments of the present invention embrace querying a management framework for information. More particularly, the present invention relates to systems and methods for querying data down to specific task requests for the performing of talents within a system, and receiving back task responses that describe the results of performing the talents. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of querying data comprising:
initiating a manager module including registering talents on a database;
receiving a request to perform a requested task and routing the request to the manager module;
analyzing the database to determine if the requested task is available; and
if the talent is available, performing the following:
transferring the request to at least one talent agent that corresponds with the requested task; and
performing the requested task.

2. The method of claim 1, wherein registering talents in a database further includes registering native talents available within the manager module on the database.

3. The method of claim 1, wherein registering talents in a database further includes registering native talents available on an agent module on the database.

4. The method of claim 1, wherein registering talents in a database further includes registering talents available by talent providers on the database.

5. The method of claim 1, wherein the database is a configuration database compiled by the execution of talent registration requests.

6. The method of claim 1, wherein a talent is an action that is capable of being performed by a talent agent.

7. The method of claim 1, wherein a talent is an action that is capable of being performed by a talent provider.

8. The method of claim 1, wherein a talent is an action that is capable of being performed by the manager module.

9. The method of claim 1, wherein the database includes a list of talents and corresponding talent agents capable of performing the talents.

10. The method of claim 1, wherein the manager module further includes a cluster of manager modules that can distribute functionality and serve as redundancy.

11. The method of claim 1, wherein the manager module may distribute task requests in order to perform the requested task more efficiently.

12. A data query module comprising:
at least one manager module configured to compile information from a database about available talents and to broadcast at least one task request to an agent that is shown to correspond to the task request in the database;
at least one agent capable of performing at least one talent, and wherein the agent is configured to record an expression of available talents onto the database; and
at least one database including information about available talents and their corresponding agents.

13. The data query module of claim 12, wherein the at least one manager module includes a plurality of manager modules distributing processes to increase efficiency and capable of backing up one another in case one or more of the plurality of manager modules fails.

14. The data query module of claim 12, wherein the at least one agent includes a plurality of agents and wherein each agent may include at least one talent provider, wherein the agents are capable of performing certain native talents and the talent providers are capable of performing other talents.

15. The data query module of claim 12, wherein the at least one database further includes:
a configuration database configured to store information about available talents and their corresponding agents;
an audit database configured to store information about requested tasks from a requester; and
a results database configured to store output information from at least one talent provider.

16. The data query module of claim 12, wherein a talent is an action capable of being performed by an agent.

17. The data query module of claim 12, wherein a talent is an action capable of being performed by a talent provider, wherein the talent provider is coupled to one of the at least one agents.

18. The data query module of claim 12, wherein a talent is an action capable of being performed by one of the at least one manager modules.

19. The data query module of claim 12, wherein at least one of the at least one agents further include at least one talent provider.

20. The data query module of claim 19, wherein each talent provider is capable of performing a talent autonomously if the corresponding agent fails.

21. The data query module of claim 12, wherein a task request is a request to perform a particular talent.

22. The data query module of claim 12, wherein the at least one manager module may distribute task requests among multiple agents in order to increase the efficiency with which the task is completed.

23. A data query module comprising:
A plurality of manager modules configured to compile information from a database about available talents and to broadcast at least one task request to a talent agent that is shown to correspond to the task request in the configuration database, wherein the plurality of manager modules distribute processes and can assume additional responsibilities if one of the plurality of manager modules fails.
at least one talent agent configured to record an expression of available talents onto the database, wherein each talent agent further includes at least one talent provider capable of performing a particular talent; and
a configuration database including information about available talents and their corresponding talent agents.

24. The data query module of claim 23, further includes an audit database configured to store information about requested tasks.

25. The data query module of claim 23, further includes a results database configured to store output information from the at least one talent providers.

26. The data query module of claim 23, wherein the at least talent providers are capable of performing requested tasks autonomously if the corresponding talent agent fails.
